(19) United States
(12) Patent Application Publication
(10) Pub. No.: US 2026/0281413 A1
(43) Pub. Date: Sep. 17, 2026

(54) IMAGE ENCODING/DECODING METHOD AND DEVICE, AND RECORDING MEDIUM ON WHICH BITSTREAM IS STORED

(71) Applicant: LG ELECTRONICS INC., Seoul (KR)

(72) Inventors: Chulkeun KIM, Seoul (KR); Hendry TAN, San Diego, CA (US); Jaehyun LIM, Seoul (KR); Junghak NAM, Seoul (KR); Jangwon LEE, Seoul (KR); Seunghwan KIM, San Diego, CA (US)

(73) Assignee: LG ELECTRONICS INC., Seoul (KR)

(21) Appl. No.: 19/670,848

(22) Filed: May 7, 2026

Related U.S. Application Data
(63) Continuation of application No. PCT/KR2025/009422, filed on Jul. 2, 2025.
(60) Provisional application No. 63/671,767, filed on Jul. 16, 2024.

(51) Int. Cl. H04N 19/46; H04N 19/136; H04N 19/169; H04N 19/172

(52) U.S. Cl. CPC H04N 19/46; H04N 19/136; H04N 19/172; H04N 19/188

(57) ABSTRACT

An image decoding method and device according to the present disclosure may receive a bitstream including an encoded video picture and reconstruct the encoded video picture included in the bitstream. Here, the bitstream may include artificial intelligence (AI) usage constraints. The AI usage constraints may include at least one of AI usage constraint information indicating constraints on AI usage, a context presence flag indicating whether context information for the AI usage constraint information is present, or context information indicating a context for the AI usage constraint information.

### CROSS-REFERENCE TO RELATED APPLICATIONS

This application is a continuation of International Application No. PCT/KR2025/009422, filed on Jul. 2, 2025, which claims the benefit of earlier filing date and right of priority to U.S. Provisional Application No. 63/671,767, filed on Jul. 16, 2024, the contents of which are all incorporated by reference herein in their entireties.

### TECHNICAL FIELD

The present disclosure relates to an image encoding/decoding method and apparatus, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure provides a method and an apparatus for configuring content usage information.

The present disclosure provides a method and an apparatus for signaling content usage information.

The present disclosure provides a method and an apparatus for configuring AI usage restrictions.

The present disclosure provides a method and an apparatus for signaling AI usage restrictions.

An image decoding method and apparatus according to the present disclosure may receive a bitstream including an encoded video picture and reconstruct the encoded video picture included in the bitstream. The bitstream may include artificial intelligence (AI) usage restrictions.

In an image decoding method and apparatus according to the present disclosure, the AI usage restrictions may include at least one of AI usage restriction information representing a restriction for AI usage, a context presence flag representing whether context information for the AI usage restriction information is present, or the context information representing a context for the AI usage restriction information.

In an image decoding method and apparatus according to the present disclosure, the AI usage restrictions may be obtained from a network abstraction layer (NAL) unit of the bitstream.

In an image decoding method and apparatus according to the present disclosure, a value of the AI usage restriction information may be restricted to fall within a range of 0 to 3.

In an image decoding method and apparatus according to the present disclosure, the AI usage restriction information of a first value may represent that it is unusable for AI training, the AI usage restriction information of a second value may represent that it is unusable for generative AI and the AI usage restriction information of a third value may represent that it is unusable in any AI application.

In an image decoding method and apparatus according to the present disclosure, a smaller value may be allocated to the AI usage restriction information representing that it is unusable for the AI training than to the AI usage restriction information representing that it is unusable for the generative AI.

In an image decoding method and apparatus according to the present disclosure, the bitstream may further include restriction number information representing the number of restriction entries to be signaled.

In an image decoding method and apparatus according to the present disclosure, at least one of the AI usage restriction information, the context presence flag or the context information may be signaled from the bitstream based on the restriction number information.

In an image decoding method and apparatus according to the present disclosure, the context information of a first value may represent a commercial use, the context information of a second value may represent a non-commercial use, the context information of a third value may represent an official government use and the context information of a fourth value may represent a research and academic use.

In an image decoding method and apparatus according to the present disclosure, the context information may be signaled from the bitstream based on a value of the context presence flag being 1, and the context information may not be signaled from the bitstream based on the value of the context presence flag being 0.

An image encoding method and apparatus according to the present disclosure may receive a video picture to be encoded, encode the received video picture to generate video information related to the video picture, generate artificial intelligence (AI) usage restrictions and generate a bitstream including the video information and the AI usage restrictions. The AI usage restrictions may include at least one of AI usage restriction information representing a restriction for AI usage, a context presence flag representing whether context information for the AI usage restriction information is present, or the context information representing a context for the AI usage restriction information. The AI usage restrictions may be encoded into a network abstraction layer (NAL) unit of the bitstream.

A computer-readable digital storage medium storing encoded video/image information that causes performing the image decoding method by a decoding apparatus according to the present disclosure is provided.

A computer-readable digital storage medium storing video/image information generated according to the image encoding method according to the present disclosure is provided.

A method and an apparatus for transmitting video/image information generated according to an image encoding method according to the present disclosure are provided.

According to the present disclosure, restrictions and recommendations for content usage applied to a bitstream may be easily confirmed by defining content usage information.

According to the present disclosure, restrictions for AI usage applied to a bitstream and a context for corresponding restrictions may be easily confirmed by defining AI usage restrictions.

### BRIEF DESCRIPTION OF THE DRAWINGS

FIG. 1 shows a video/image coding system according to the present disclosure.

FIG. 2 shows a schematic block diagram of an encoding apparatus to which an embodiment of the present disclosure is applicable and encoding of video/image signals is performed.

FIG. 3 shows a schematic block diagram of a decoding apparatus to which an embodiment of the present disclosure is applicable and decoding of video/image signals is performed.

FIG. 4 illustrates a method for reconstructing a video picture performed by the decoding apparatus 300 according to the present disclosure.

FIG. 5 illustrates a schematic configuration of the decoding apparatus 300 that performs a method for reconstructing a video picture according to the present disclosure.

FIG. 6 illustrates a method for generating a bitstream performed by the encoding apparatus 200 according to the present disclosure.

FIG. 7 illustrates a schematic configuration of the encoding apparatus 200 that performs a method for generating a bitstream according to the present disclosure.

FIG. 8 shows an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, the first component may be referred to as the second component without departing from the scope of a right of the present disclosure, and similarly, the second component may also be referred to as the first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex.H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular area composed of a plurality of CTUs within a specific tile column and a specific tile row of one picture. A tile column is a rectangular area of CTUs having the same height as that of a picture and a width designated by a syntax requirement of a picture parameter set. A tile row is a rectangular area of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular area of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific area of a picture and information related to a corresponding area. One unit may include one luma block and two chroma (ex. cb, cr) blocks. In some cases, a unit may be used interchangeably with a term such as a block or an area, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

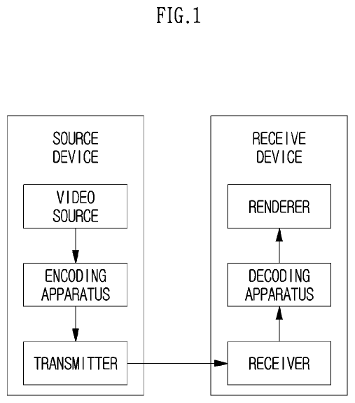

FIG. 1 shows a video/image coding system according to the present disclosure.

Referring to FIG. 1, a video/image coding system may include the first device (a source device) and the second device (a receiving device).

A source device may transmit encoded video/image information or data in a form of a file or streaming to a receiving device through a digital storage medium or a network. The source device may include a video source, an encoding apparatus and a transmission unit. The receiving device may include a reception unit, a decoding apparatus and a renderer. The encoding apparatus may be referred to as a video/image encoding apparatus and the decoding apparatus may be referred to as a video/image decoding apparatus. A transmitter may be included in an encoding apparatus. A receiver may be included in a decoding apparatus. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus may encode an input video/image. An encoding apparatus may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding apparatus.

A decoding apparatus may decode a video/an image by performing a series of procedures such as dequantization, inverse transform, prediction, etc. corresponding to an operation of an encoding apparatus.

A renderer may render a decoded video/image. A rendered video/image may be displayed through a display unit.

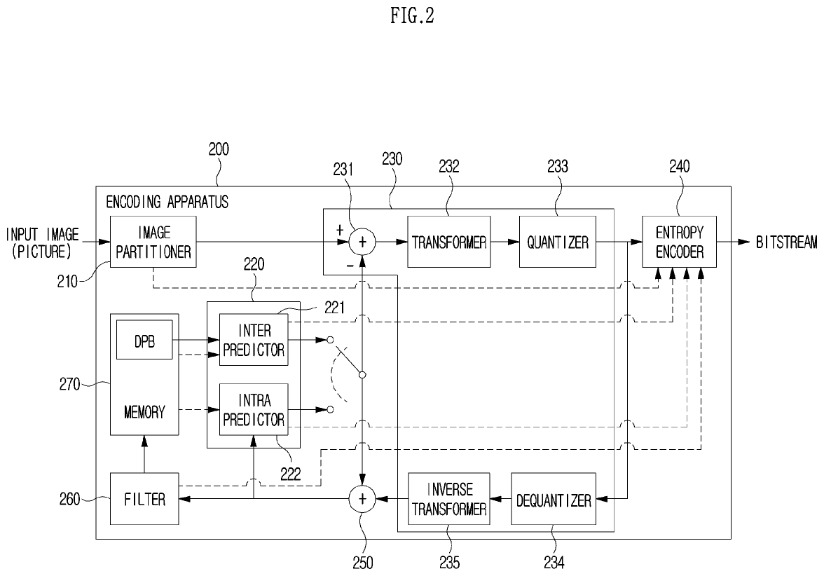

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an area, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a neighboring block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may reorder quantized transform coefficients in a block form into a 1D vector form based on coefficient scan order, and may generate information on the quantized transform coefficients based on the quantized transform coefficients in the 1D vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

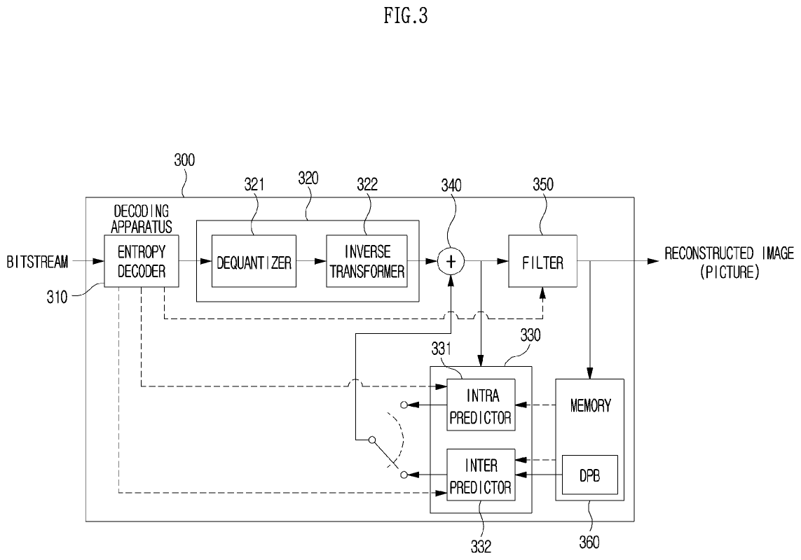

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 332 and an intra predictor 331. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a neighboring block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may reorder quantized transform coefficients into a two-dimensional block form. In this case, the reordering may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 332 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

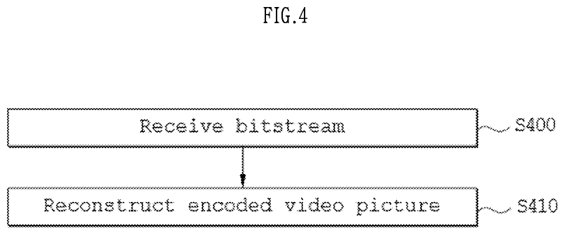

FIG. 4 illustrates a method for reconstructing a video picture performed by the decoding apparatus 300 according to the present disclosure.

A bitstream including an encoded video picture may be received S400.

The encoded video picture of a bitstream may be reconstructed S410.

Video information related to an encoded video picture may be extracted from a bitstream. An encoded video picture may be reconstructed based on extracted video information.

### Embodiment 1

A bitstream may include content usage information (CUI). Content usage information is related to information related to a method for using a picture, and may include restrictions, recommendations, etc. related to picture usage for a usage subject and use. Hereinafter, content usage information is described in detail.

Content usage information may include a CUI cancellation flag (cui_cancel_flag). When cui_cancel_flag is 1, it may represent that the persistence of previous content usage information is canceled, and when cui_cancel_flag is 0, it may represent that content usage information persists.

Content usage information may include a CUI persistence flag (cui_persistence_flag). cui_persistence_flag may represent persistence for content usage information. When cui_persistence_flag is 0, it may represent that content usage information may be applied only to a current picture. When cui_persistence_flag is 1, it may represent that content usage information may be applied to a current picture and all subsequent pictures.

Hereinafter, a method for configuring content usage information is described in detail.

TABLE 1

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context_minus1 | u(8) |
| for (i = 0; i <= cui_num_context_minus1; i++) { | |
| cui_context_present_flag[i] | u(1) |
| if(cui_context_present_flag[i]) | |
| cui_context[i] | ue(v) |
| cui_usage_category[i] | ue(v) |
| if (cuiForAIFlag[i]) { | |
| cui_usage_for_ai[i] | ue(v) |
| } | |
| if (cuiForEditingFlag[i]) { | |
| cui_usage_for_editing[i] | ue(v) |
| } | |
| } | |
| } | |
| } | |

Context number information (cui_num_context_minus1) may specify the number of context entries. As an example, a value obtained by adding 1 to cui_num_context_minus1 may be set as the number of context entries.

A context presence flag (cui_context_present_flag[i]) may represent whether the i-th context information (cui_context[i]) is present. For example, when cui_context_present_flag[i] is 1, it may represent that the i-th cui_context is present, and when cui_context_present_flag[i] is 0, it may represent that the i-th cui_context is not present. When cui_context_present_flag[i] is 0, at least one of the i-th category information (cui_usage_category[i]), the i-th AI usage restriction information (cui_usage_for_ai[i]) or the i-th editing usage restriction information (cui_usage_for_editing[i]) may be applied to all cases regardless of a context.
cui_context[i] may represent the i-th context for at least one of cui_usage_for_ai[i] or cui_usage_for_editing[i]. The value of cui_context may be restricted to be in the range of 0 to 3. When the value of cui_context is in the range of 4 to 65,535, it may be reserved for future usage and a decoder with specific specifications shall ignore cui_usage_for_editing.

TABLE 2

| cui_context | Interpretation |
|---|---|
| 0 | commercial use |
| 1 | non-commercial use |
| 2 | official government use |
| 3 | research and academic use |

cui_usage_category[i] may represent the i-th usage category of a picture as defined in Table 3. When (cui_usage_category[i] & bitMask) is not 0, it may represent that a usage category corresponding to a bitMask value in Table 3 is included. When cui_usage_category[i] is 0, a usage category may be defined by an application. The value of cui_usage_category[i] may be restricted to be in the range of 0 to 3. When the value of cui_usage_category[i] is in the range of 4 to 65,535, it may be reserved for future usage and a decoder with specific specifications shall ignore cui_usage_category[i].

TABLE 3

| bitMask | Interpretation |
|---|---|
| 0x01 | AI process usage. This SEI includes information on how associated pictures |
| | may be used with AI processes |
| 0x02 | Editing usage. This SEI includes information on how associated pictures may |
| | be used for editing or modification purposes |

cuiForAIFlag[i] may specify whether cui_usage_category[i] represents a usage category including AI process usage. cuiForEditingFlag[i] may specify whether cui_usage_category[i] represents a usage category including AI editing usage. cuiForAIFlag[i] and cuiForEditingFlag[i] may be derived as follows, respectively.

$$cuiForAIFlag [ i ] = ( ( cui\_usage \_category [ i ] \& 0 x 01 ) > 0 ) ? 1 : 0$$

$$cuiForEditingFlag [ i ] = ( ( cui\_usage \_category [ i ] \& 0 x 02 ) > 0 ) ? 1 : 0$$

When cui_usage_for_ai[i] exists, it may represent the i-th usage information related to AI as defined in Table 4. When (cui_usage_for_ai[i] & bitMask) is not 0, it may represent that usage information corresponding to a bitMask value in Table 4 is applied. When cui_usage_for_ai[i] is 0, usage information may be defined by an application. The value of cui_usage_for_ai[i] may be restricted to be in the range of 0 to 7. When the value of cui_usage_for_ai[i] is in the range of 8 to 65,535, it may be reserved for future usage and a decoder with specific specifications shall ignore cui_usage_for_ai[i].

TABLE 4

| bitMask | Interpretation |
|---|---|
| 0x01 | Usage information related to AI training; Indicates that pictures related to |
| | content usage information may be used for AI training |
| 0x02 | Usage information related to AI inference; Indicates that pictures related to |
| | content usage information may be used for AI inference |
| 0x04 | Usage information related to AI synthesis: Indicates that pictures related to |
| | content usage information may be used for AI synthesis |

cuiAllowedForAITrainingFlag[i] may specify whether a picture related to an SEI message is usable for AI training. cuiAllowedForAIInferencingFlag[i] may specify whether a picture related to an SEI message is usable for AI inference. cuiAllowedForAISynthesisFlag[i] may specify whether a picture related to an SEI message is usable for AI synthesis. cuiAllowedForAITrainingFlag[i], cuiAllowedForAIInferencingFlag[i] and cuiAllowedForAISynthesisFlag[i] may be derived as follows, respectively.

$$cui AllowedForAITrainingFlag [ i ] = ( ( cui\_usage \_for \_ai [ i ] \& 0 x 01 ) > 0 ) ? 1 : 0$$

$$cui AllowedForAIInferenceFlag [ i ] = ( ( cui\_usage \_for \_ai [ i ] \& 0 x 02 ) > 0 ) ? 1 : 0$$

$$cui AllowedForAISynthesisFlag [ i ] = ( ( cui\_usage \_for \_ai [ i ] \& 0 x 04 ) > 0 ) ? 1 : 0$$

cui_usage_for_editing[i] may represent the i-th usage information related to editing as defined in Table 5. When (cui_usage_for_editing[i] & bitMask) is not 0, it may represent that usage information corresponding to a bitMask value in Table 5 is applied. When cui_usage_for_editing[i] is 0, usage information may be defined by an application. The value of cui_usage_for_editing[i] may be restricted to be in the range of 0 to 7. When the value of cui_usage_for_editing[i] is in the range of 8 to 65,535, it may be reserved for future usage and a decoder with specific specifications shall ignore cui_usage_for_editing[i].

TABLE 5

| bitMask | Interpretation |
|---|---|
| 0x01 | Usage information related to cropping: Identifies that the picture may be |
| | cropped |
| 0x02 | Usage information related to colorization: Identifies that the picture may be |
| | colorized |
| 0x04 | Usage information related to masking: Identifies that the picture may be masked |

cuiAllowedForCroppingflag[i] may specify whether a picture related to an SEI message is usable for cropping. cuiAllowedForColorizationFlag[i] may specify whether a picture related to an SEI message is usable for colorization. cuiAllowedForMaskingFlag[i] may specify whether a picture related to an SEI message is usable for masking. cuiAllowedForCroppingflag[i], cuiAllowedForColorizationFlag[i] and cuiAllowedForMaskingFlag[i] may be derived as follows.

$$cui AllowedForCroppingflag [ i ] = ( ( cui\_usage \_for \_editing [ i ] \& 0 x 01 ) > 0 ) ? 1 : 0$$

$$cui AllowedForColorizationFlag [ i ] = ( ( cui\_usage \_for \_editing [ i ] \& 0 x 02 ) > 0 ) ? 1 : 0$$

$$cui AllowedForMaskingFlag [ i ] = ( ( cui\_usage \_for \_editing [ i ] \& 0 x 04 ) > 0 ) ? 1 : 0$$

TABLE 6

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context | u(8) |
| for (i = 0; i <= cui_num_context; i++) { | |
| If(cui_num_context ) | |
| cui_context[i] | ue(v) |
| cui_usage_category[i] | ue(v) |
| if (cuiForAIFlag[i]) { | |
| cui_usage_for_ai[i] | ue(v) |
| } | |
| if (cuiForEditingFlag[i]) { | |
| cui_usage_for_editing[i] | ue(v) |
| } | |
| } | |
| } | |
| } | |

Context number information (cui_num_context) may specify the number of context entries. As an example, the value of cui_num_context may be set as the number of context entries. When the value of cui_num_context is 0, it may represent that cui_context is not present. When the value of cui_num_context is 0, information defined in at least one of cui_usage_category, cui_usage_for_ai or cui_usage_for_editing may be applied to all cases regardless of a context.
cui_context[i], cui_usage_category[i], cui_usage_for_ai[i] and cui_usage_for_editing[i] are the same as described by referring to Table 1.

TABLE 7

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context_minus1 | u(8) |
| for (i = 0; i <= cui_num_context_minus1; i++) { | |
| cui_context[i] | ue(v) |
| cui_usage_category[i] | ue(v) |
| if (cuiForAIFlag[i]) { | |
| cui_usage_for_ai[i] | ue(v) |
| } | |
| if (cuiForEditingFlag[i]) { | |
| cui_usage_for_editing[i] | ue(v) |
| } | |
| } | |
| } | |
| } | |

cui_context[i] may represent the i-th context for at least one of cui_usage_for_ai[i] or cui_usage_for_editing[i] as defined in Table 8. The value of cui_context may be restricted to be in the range of 0 to 3. When the value of cui_context is in the range of 4 to 65,535, it may be reserved for future usage and a decoder with specific specifications shall ignore cui_context.

TABLE 8

| cui_context | Interpretation |
|---|---|
| 0 | All contexts |
| 1 | commercial use |
| 2 | non-commercial use |
| 3 | official government use |
| 4 | research and academic use |

cui_num_context_minus1, cui_usage_category[i], cui_usage_for_ai[i] and cui_usage_for_editing[i] in Table 7 are the same as described by referring to Table 1.

TABLE 9

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context_minus1 | u(8) |
| for (i = 0; i <= cui_num_context_minus1; i++) { | |
| cui_context_present_flag[i] | u(1) |
| if(cui_context_present_flag[i]) | |
| cui_context[i] | ue(v) |
| cui_usage[i] | ue(v) |
| } | |
| } | |
| } | |

cui_usage[i] may represent the i-th usage information defined in Table 10. When (cui_usage[i] & bitMask) is not 0, it may represent that usage information corresponding to a bitMask value in Table 10 is applied. When cui_usage[i] is 0, usage information may be defined by an application. The value of cui_usage[i] may be restricted to be in the range of 0 to 63. When the value of cui_usage[i] is in the range of 64 to 65,535, it may be reserved for future usage and a decoder with specific specifications shall ignore cui_usage[i].

TABLE 10

| bitMask | Interpretation |
|---|---|
| 0x01 | Usage information related to AI training; Indicates that pictures related to |
| | content usage information may be used for AI training |
| 0x02 | Usage information related to AI inference; Indicates that pictures related to |
| | content usage information may be used for AI inference |
| 0x04 | Usage information related to AI synthesis: Indicates that pictures related to |
| | content usage information may be used for AI synthesis |
| 0x08 | Usage information related to cropping: Identifies that the picture may be |
| | cropped |
| 0x10 | Usage information related to colorization: Identifies that the picture may be |
| | colorized |
| 0x20 | Usage information related to masking: Identifies that the picture may be masked |

cui_num_context_minus1, cui_context_present_flag[i] and cui_context[i] in Table 9 are the same as described by referring to Table 1.

Content usage information may also be configured as shown in Table 11 below. cui_num_context, cui_context[i] and cui_usage[i] in Table 11 are the same as described before, and an overlapping description will be omitted here.

TABLE 11

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context | u(8) |
| for (i = 0; i <= cui_num_context; i++) { | |
| if(cui_num_context) | |
| cui_context[i] | ue(v) |
| cui_usage[i] | ue(v) |
| } | |
| } | |
| } | |

Content usage information may also be configured as shown in Table 12 below. cui_num_context_minus1, cui_context[i] and cui_usage[i] in Table 12 are the same as described before, and an overlapping description will be omitted here.

TABLE 12

| | Descriptor |
|---|---|
| content_usage_information(payloadSize) { | |
| cui_cancel_flag | u(1) |
| if (!cui_cancel_flag) { | |
| cui_persistence_flag | u(1) |
| cui_num_context_minus1 | u(8) |
| for (i = 0; i <= cui_num_context_minus1 ; i++) { | |
| cui_context[i] | ue(v) |
| cui_usage[i] | ue(v) |
| } | |
| } | |
| } | |

Content usage information may also be configured as shown in Table 13 below.

TABLE 13

| | Descriptor |
|---|---|
| content_usage_information( payloadSize ) { | |
| cui_cancel_flag | u(1) |
| if( !cui_cancel_flag ) { | |
| cui_persistence_flag | u(1) |
| cui_usage_category | ue(v) |
| if(cuiForAIFlag){ | |
| cui_usage_for_ai | ue(v) |
| cui_context_for_ai_present_flag | u(1) |
| if(cui_context_for_ai_present_flag) | |
| cui_context_for_ai | ue(v) |
| } | |
| if(cuiForEditingFlag){ | |
| cui_usage_for_editing | ue(v) |
| cui_context_for_editing_present_flag | u(1) |
| if(cui_context_for_editing_present_flag) | |
| cui_context_for_editing | ue(v) |
| } | |
| } | |
| } | |

cui_usage_category, cui_usage_for_ai and cui_usage_for_editing in Table 13 are the same as described before, and an overlapping description will be omitted here.
cui_context_for_ai_present_flag may represent whether context information for the value of cui_usage_for_ai (cui_context_for_ai) is present. For example, when cui_context_for_ai_present_flag is 1, it may represent that cui_context_for_ai is present, and when cui_context_for_ai_present_flag is 0, it may represent that cui_context for ai is not present. When cui_context_for_ai_present_flag is 0, usage information defined in cui_usage_for_ai may be applied to all cases regardless of a context.
cui_context_for_ai may represent the context of cui_usage_for_ai defined in Table 14. When (cui_context_for_ai & bitMask) is not 0, it may represent that a context corresponding to a bitMask value in Table 14 is applied. When cui_context_for_ai is greater than 0 and (cui_context_for_ai & bitMask) is 0, a context corresponding to a bitMask value may not be applied. cui_context_for_ai may be restricted from having a value of 0.

TABLE 14

| Bitmask | Interpretation |
|---|---|
| 0x0001 | commercial use |
| 0x0002 | non-commercial use |
| 0x0004 | official government use |
| 0x0004 | research and academic use |
| 0x0008 to | Reserved for future use of ITU and ISO |
| 0xFFFF | |

cui_context_for_editing_present_flag may represent whether context information for the value of cui_usage_for_editing (cui_context_for_editing) is present. For example, when cui_context_for_editing_present_flag is 1, it may represent that cui_context_for_editing is present, and when cui_context_for_editing_present_flag is 0, it may represent that cui_context_for_editing is not present. When cui_context_for_editing_present_flag is 0, usage information defined in cui_usage_for_editing may be applied to all cases regardless of a context.
cui_context_for_editing may represent the context of cui_usage_for_editing defined in Table 15. When (cui_context_for_editing & bitMask) is not 0, it may represent that a context corresponding to a bitMask value in Table 15 is applied. When cui_context_for_editing is greater than 0 and (cui_context_for_editing & bitMask) is 0, a context corresponding to a bitMask value may not be applied. cui_context_for_editing may be restricted from having a value of 0.

TABLE 15

| Bitmask | Interpretation |
|---|---|
| 0x0001 | commercial use |
| 0x0002 | non-commercial use |
| 0x0004 | official government use |
| 0x0004 | research and academic use |
| 0x0008 to | Reserved for future use of ITU and ISO |
| 0xFFFF | |

Content usage information may also be configured as shown in Table 16 below.

TABLE 16

| | Descriptor |
|---|---|
| content_usage_information( payloadSize ) { | |
| cui_cancel_flag | u(1) |
| if( !cui_cancel_flag ) { | |
| cui_persistence_flag | u(1) |
| cui_usage_category | ue(v) |
| if(cuiForAIFlag) | |
| cui_usage_for_ai | ue(v) |
| if(cuiForEditingFlag) | |
| cui_usage_for_editing | ue(v) |
| } | |
| } | |

cui_usage_category in Table 16 is the same as described before.
cui_usage_for_ai may represent Ai-related usage information defined in Table 17. When (cui_usage_for_ai & bitMask) is not 0, it may represent that usage information corresponding to a bitMask value in Table 17 is applied. When cui_usage_for_ai is 0, usage information may be defined by an application. The value of cui_usage_for_ai may be restricted to be in the range of 0 to 7. When the value of cui_usage_for_ai is in the range of 8 to 65,535, it may be reserved for future usage and a decoder with specific specifications shall ignore cui_usage_for_ai.

TABLE 17

| bitMask | Interpretation |
|---|---|
| 0x01 | Usage information related to AI training; Indicates that pictures related to |
| | content usage information should not be used for AI training |
| 0x02 | Usage information related to AI inference; Indicates that pictures related to |
| | content usage information should not be used for AI inference |
| 0x04 | Usage information related to AI synthesis: Indicates that pictures related to |
| | content usage information should not be used for AI synthesis |

cuiDisallowedForAITrainingFlag may specify whether a picture related to an SEI message is unusable for AI training. cuiDisallowedForAIInferencingFlag may specify whether a picture related to an SEI message is unusable for AI inference.
cuiDisallowedForAISynthesisFlag may specify whether a picture related to an SEI message is unusable for AI synthesis. cuiDisallowedForAITrainingFlag, cuiDisallowedForAIInferencingFlag and cuiDisallowedForAISynthesisFlag may be derived as follows, respectively.

$$cuiDisallowedForAITrainingFlag = ( ( cui\_usage \_for \_ai \& 0 x 01 ) > 0 ) ? 1 : 0$$

$$cuiDisallowedForAIInferenceFlag = ( ( cui\_usage \_for \_ai \& 0 x 02 ) > 0 ) ? 1 : 0$$

$$cuiDisallowedForAISynthesisFlag = ( ( cui\_usage \_for \_ai \& 0 x 04 ) > 0 ) ? 1 : 0$$

cui_usage_for_editing may represent editing-related usage information defined in Table 18. When (cui_usage_for_editing & bitMask) is not 0, it may represent that usage information corresponding to a bitMask value in Table 18 is applied. When cui_usage_for_editing is 0, usage information may be defined by an application. The value of cui_usage_for_editing may be restricted to be in the range of 0 to 7. When the value of cui_usage_for_editing is in the range of 8 to 65,535, it may be reserved for future usage and a decoder with specific specifications shall ignore cui_usage_for_editing.

TABLE 18

| bitMask | Interpretation |
|---|---|
| 0x01 | Usage information related to cropping: Identifies that the picture should not be |
| | cropped |
| 0x02 | Usage information related to colorization: Identifies that the picture should not |
| | be colorized |
| 0x04 | Usage information related to masking: Identifies that the picture should not be masked |

cuiDisallowedForCroppingflag may specify whether a picture related to an SEI message is unusable for cropping. cuiDisallowedForColorizationFlag may specify whether a picture related to an SEI message is unusable for colorization. cuiDisallowedForMaskingFlag may specify whether a picture related to an SEI message is unusable for masking. cuiDisallowedForCroppingflag, cuiDisallowedForColorizationFlag and cuiDisallowedForMaskingFlag may be derived as follows, respectively.

$$cuiDisallowedForCroppingflag = ( ( cui\_usage \_for \_editing \& 0 x 01 ) > 0 ) ? 1 : 0$$

$$cuiDisallowedForColorizationFlag = ( ( cui\_usage \_for \_editing \& 0 x 02 ) > 0 ) ? 1 : 0$$

$$cuiDisallowedForMaskingFlag = ( ( cui\_usage \_for \_editing \& 0 x 04 ) > 0 ) ? 1 : 0$$

Content usage information may be configured in the supplemental enhancement information (SEI) message of a bitstream. An SEI message may be included in the network abstraction layer (NAL) unit of a bitstream. All or a part of the content usage information may also be configured in an SEI message where AI usage restriction information described below is defined. Alternatively, content usage information according to the present disclosure may also be configured in the high-level syntax of a bitstream. Here, a high-level syntax may be at least one of a sequence parameter set (SPS), a picture parameter set (PPS), a picture header (PH) or a slice header (SH). Alternatively, content usage information according to the present disclosure may also be defined as a separate NAL unit type within a bitstream.

### Embodiment 2

A bitstream may include AI usage restrictions (AUR). AI usage restrictions may represent at least one of restriction information, an optional context or contact information for usage by an AI application.

AI usage restrictions may include an AUR cancellation flag (aur_cancel_flag). When aur_cancel_flag is 1, it may represent that an SEI message cancels the persistence of previous AI usage restrictions in output order. When aur_cancel_flag is 0, it may represent that AI usage restrictions follow.

AI usage restrictions may include an AUR persistence flag (aur_persistence_flag). aur_persistence_flag may represent the persistence of AI usage restrictions for a current layer. As an example, when aur_persistence_flag is 0, it may represent that AI usage restrictions are applied only to a currently decoded picture. When aur_persistence_flag is 1, it may represent that AI usage restrictions are applied to a currently decoded picture and persist for all subsequent pictures belonging to a current layer.

AI usage restrictions may include restriction number information (aur_num_restrictions_minus1). aur_num_restrictions_minus1 may represent the number of restriction entries to be signaled. As an example, a value obtained by adding 1 to aur_num_restrictions_minus1 may be the number of restriction entries to be signaled.

AI usage restrictions may include AI usage restriction information (aur_restriction). aur_restriction may represent restriction or no restriction for usage for a specific use. aur_restriction may be signaled based on aur_num_restrictions_minus1. aur_restriction may be signaled as many as the number of restriction entries according to aur_num_restrictions_minus1.

As an example, aur_restriction may be defined as shown in Table 19 below.

TABLE 19

| aur_restriction | Interpretation |
|---|---|
| 0 | Do not use for AI training |
| 1 | Do not use for generative (modification or creation) AI |
| 2 | Do not use in any AI application |

When the value of aur_restriction is the first value (e.g., when the value of aur_restriction is 0), it may represent that it is not used (or, unusable) for AI training. When the value of aur_restriction is the second value (e.g., when the value of aur_restriction is 1), it may represent that it is not used (or, unusable) for generative AI. When the value of aur_restriction is the third value (e.g., when the value of aur_restriction is 2), it may represent that it is not used (or, unusable) in any AI application.

The value of aur_restriction may be restricted to be in the range of 0 to 2. When the value of aur_restriction is in the range of 3 to 65,535, it may be reserved for future usage and a decoder with specific specifications shall ignore aur_restriction.

Alternatively, aur_restriction may also be defined as shown in Table 20 below.

TABLE 20

| aur_restriction | Interpretation |
|---|---|
| 0 | No restriction |
| 1 | Do not use for AI training |
| 2 | Do not use for AI inferencing |
| 3 | Do not use for generative (modification or creation) AI |
| 4 | Do not use in any AI application |

When the value of aur_restriction is the first value (e.g., when the value of aur_restriction is 1), it may represent that it is not used (or, unusable) for AI training. When the value of aur_restriction is the second value (e.g., when the value of aur_restriction is 2), it may represent that it is not used (or, unusable) for AI inferencing. When the value of aur_restriction is the third value (e.g., when the value of aur_restriction is 3), it may represent that it is not used (or, unusable) for generative AI. When the value of aur_restriction is the fourth value (e.g., when the value of aur_restriction is 4), it may represent that it is not used (or, unusable) in any AI application.

The value of aur_restriction may be restricted to be in the range of 0 to 4. When the value of aur_restriction is in the range of 5 to 65,535, it may be reserved for future usage and a decoder with specific specifications shall ignore aur_restriction.

AI usage restrictions may include a context presence flag (aur_context_present_flag). aur_context_present_flag may represent whether context information for the value of aur_restriction (aur_context) is present. As an example, when aur_context_present_flag is 1, it may represent that aur_context is present, and when aur_context_present_flag is 0, it may represent that aur_context is not present. When aur_context_present_flag is 0, a restriction defined in aur_restriction may be applied to all cases regardless of a context.
aur_context_present_flag may be signaled based on aur_num_restrictions_minus1. aur_context_present_flag may be signaled as many as the number of restriction entries according to aur_num_restrictions_minus1.

AI usage restrictions may include context information (aur_context). aur_context may represent a context for aur_restriction. As an example, aur_context may be defined as in Table 21.

TABLE 21

| Bitmask | Interpretation |
|---|---|
| 0x0001 | commercial use |
| 0x0002 | non-commercial |
| | use |
| 0x0004 | official government use |
| 0x0008 | research and academic use |
| 0x0010 to | Reserved for future use of ITU and ISO |
| 0xFFFF | |

When (aur_context & bitMask) is not 0, it may represent that a context corresponding to a bitMask value in Table 21 is applied. When aur_context is greater than 0 and (aur_context & bitMask) is 0, a context corresponding to a bitMask value may not be applied. aur_context may be restricted from having a value of 0.
aur_context may be signaled based on at least one of aur_num_restrictions_minus1 or aur_context_present_flag. aur_context may be signaled as many as the number of restriction entries according to aur_num_restrictions_minus1. aur_context may be signaled based on a value of aur_context_present_flag being 1, and may not be signaled based on a value of aur_context_present_flag being 0.

AI usage restrictions may include a contact information presence flag (aur_contact_info_present_flag). aur_contact_info_present_flag may represent whether contact information for AI usage restrictions (aur_contact_info) is present.
aur_payload_bit_equal_to_zero shall be the same as 0. aur_contact_info may include a string that shall include contact information for an entity from which additional information may be obtained.

As an example, AI usage restrictions may be configured as shown in Table 22 below.

TABLE 22

| | Descriptor |
|---|---|
| AI_usage_restrictions ( payloadSize ) { | |
| aur_cancel_flag | u(1) |
| if (!aur_cancel_flag) { | |
| aur_persistence_flag | u(1) |
| aur_num_restrictions_minus1 | u(8) |
| for( i = 0; i <= aur_num_restrictions_minus1; i++ ){ | |
| aur_restriction | ue(v) |
| aur_context_present_flag | u(1) |
| if (aur_context_present_flag) | |
| aur_context | ue(v) |
| } | |
| aur_contact_info_present_flag | u(1) |
| if (aur_contact_info_present_flag) { | |
| while (!byte_aligned( )) | |
| aur_payload_bit_equal_to_zero | f(1) |
| aur_contact_info | st(v) |
| } | |
| } | |
| } | |

AI usage restrictions may include AI usage restriction information (aur_restriction[i]). Here, aur_restriction[i] may specify the i-th restriction.

As an example, aur_restriction[i] may be defined as shown in Table 23 below.

TABLE 23

| Bitmask | Interpretation |
|---|---|
| 0 | No restriction |
| 1 | Do not use for AI training |
| 2 | Do not use for generative (modification or creation) AI |
| 3 | Do not use in any AI application |
| 4~255 | Reserved for future use of ITU and ISO |

When the value of aur_restriction[i] is the first value (e.g., when the value of aur_restriction[i] is 1), it may represent that it is not used (or, unusable) for AI training. When the value of aur_restriction[i] is the second value (e.g., when the value of aur_restriction[i] is 2), it may represent that it is not used (or, unusable) for generative AI. When the value of aur_restriction[i] is the third value (e.g., when the value of aur_restriction[i] is 3), it may represent that it is not used (or, unusable) in any AI application.

The value of aur_restriction[i] may be restricted to fall within the range of 0 to 3. A value falling within the range of 4 to 255 for aur_restriction[i] may be reserved for future use. A decoder with specific specifications shall allow the value of aur_restriction[i] falling within the range of 0 to 255. aur_restriction[i] may be signaled based on aur_num_restrictions_minus1. aur_restriction[i] may be signaled as many as the number of restriction entries according to aur_num_restrictions_minus1.

AI usage restrictions may include a context presence flag (aur_context_present_flag[i]). aur_context_present_flag[i] may represent whether context information for the value of aur_restriction[i] (aur_context[i]) is present. As an example, when aur_context_present_flag[i] is 1, it may represent that aur_context[i] is present, and when aur_context_present_flag[i] is 0, it may represent that aur_context[i] is not present. When aur_context_present_flag[i] is 0, a restriction defined in aur_restriction[i] may be applied to all cases regardless of a context. aur_context_present_flag[i] may be signaled based on aur_num_restrictions_minus1. aur_context_present_flag[i] may be signaled as many as the number of restriction entries according to aur_num_restrictions_minus1.

AI usage restrictions may include context information (aur_context[i]). aur_context[i] may represent a context for the i-th restriction. As an example, aur_context[i] may be defined as shown in Table 24.

TABLE 24

| Bitmask | Interpretation |
|---|---|
| 0x0001 | commercial use |
| 0x0002 | non-commercial |
| | use |
| 0x0004 | official government use |
| 0x0008 | research and academic use |
| 0x0010 to | Reserved for future use of ITU and ISO |
| 0xFFFF | |

When (aur_context & bitMask) is not 0, it may represent that a context corresponding to a bitMask value in Table 24 is applied to the i-th restriction. When aur_context[i] is greater than 0 and (aur_context[i] & bitMask) is 0, a context corresponding to a bitMask value may or may not be applied to the i-th restriction.

The value of aur_context[i] may be restricted to fall within the range of 1 to 15. A value falling within the range of 16 to 65,535 for aur_context[i] may be reserved for future use. When the value of aur_context[i] falls within the range of 16 to 65,535, a decoder with specific specifications shall ignore aur_context[i].
aur_context[i] may be signaled based on at least one of aur_num_restrictions_minus1 or aur_context_present_flag[i]. aur_context[i] may be signaled as many as the number of restriction entries according to aur_num_restrictions_minus1. aur_context[i] may be signaled based on the value of aur_context_present_flag[i] being 1, and may not be signaled based on the value of aur_context_present_flag[i] being 0. As an example, AI usage restrictions may be configured as shown in Table 25 below.

TABLE 25

| | Descriptor |
|---|---|
| AI_usage_restrictions ( payloadSize ) { | |
| aur_cancel_flag | u(1) |
| if (!aur_cancel_flag) { | |
| aur_persistence_flag | u(1) |
| aur_num_restrictions_minus1 | u(8) |
| for( i = 0; i <= aur_num_restrictions_minus1; i++ ){ | |
| aur_restriction | ue(v) |
| aur_context_present_flag | u(1) |
| if (aur_context_present_flag) | |
| aur_context | ue(v) |
| } | |
| } | |
| } | |

AI usage restriction information may be configured in the supplemental enhancement information (SEI) message of a bitstream. An SEI message may be included in the network abstraction layer (NAL) unit of a bitstream. Alternatively, AI usage restriction information according to the present disclosure may also be configured in the high-level syntax of a bitstream. Here, a high-level syntax may be at least one of a sequence parameter set (SPS), a picture parameter set (PPS), a picture header (PH) or a slice header (SH). Alternatively, AI usage restriction information according to the present disclosure may also be defined as a separate NAL unit type within a bitstream.

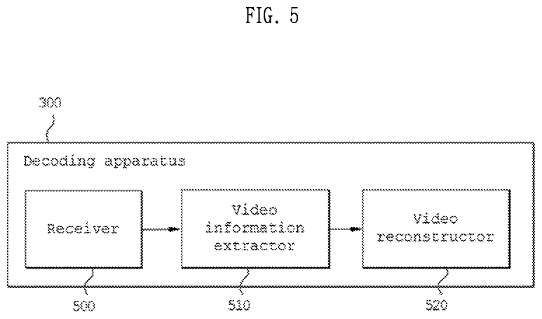

FIG. 5 illustrates a schematic configuration of the decoding apparatus 300 that performs a method for reconstructing a video picture according to the present disclosure.

Referring to FIG. 5, the decoding apparatus 300 may include the receiver 500, the video information extractor 510 and the video reconstructor 520.

The receiver 500 may receive a bitstream including an encoded video picture.

The video information extractor 510 may extract video information related to an encoded video picture from a bitstream. In addition, the video information extractor 710 may extract at least one of content usage information or AI usage restrictions from a bitstream, which is the same as described by referring to FIG. 4.

The video reconstructor 520 may reconstruct an encoded video picture based on extracted video information.

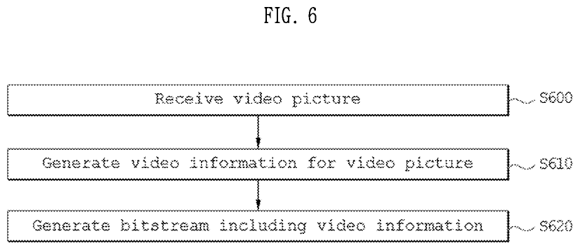

FIG. 6 illustrates a method for generating a bitstream performed by the encoding apparatus 200 according to the present disclosure.

A video picture to be encoded may be received S600.

A received video picture may be encoded to generate video information related to a video picture S610.

A bitstream including video information related to a video picture may be generated S420.

In addition, at least one of content usage information or AI usage restrictions applied to a bitstream may be generated, which is the same as described by referring to FIG. 4. At least one of the generated content usage information or AI usage restrictions may be included in a bitstream.

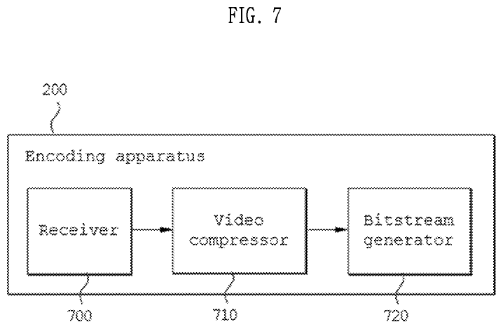

FIG. 7 illustrates a schematic configuration of the encoding apparatus 200 that performs a method for generating a bitstream according to the present disclosure.

Referring to FIG. 7, the encoding apparatus 200 may include the receiver 700, the video compressor 710 and the bitstream generator 720.

The receiver 700 may receive one or more video pictures to be encoded.

The video compressor 710 may encode one or more received video pictures to generate video information related to a video picture. The video compressor 710 may generate at least one of content usage information or AI usage restrictions applied to a bitstream.

The bitstream generator 720 may generate a bitstream including the video information. The bitstream generator 720 may generate a bitstream further including at least one of the generated content usage information or AI usage restrictions.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VOD) service, an over the top video (OTT) device, a device for providing Internet streaming service, a three-dimensional (3D) video device, a virtual reality (VR) device, an augmented reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

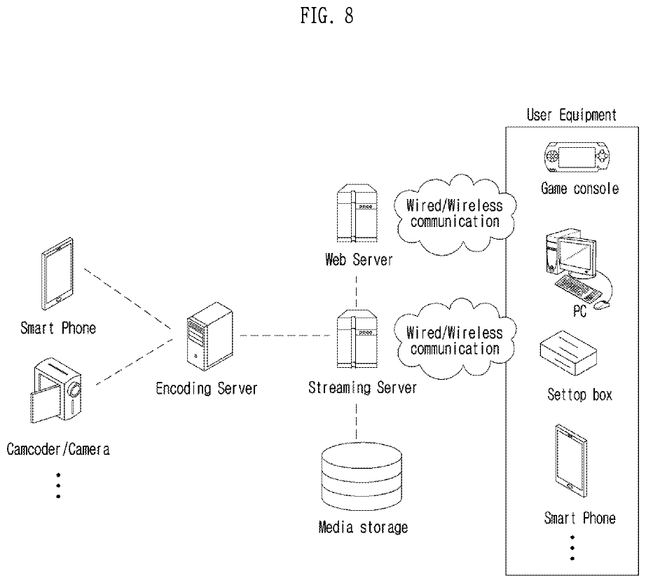

FIG. 8 shows an example of a contents streaming system to which embodiments of the present disclosure may be applied.

Referring to FIG. 8, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

What is claimed is:

1. A method, comprising:
receiving a bitstream including an encoded video picture; and
reconstructing the encoded video picture included in the bitstream,
wherein the bitstream includes artificial intelligence (AI) usage restrictions,
wherein the AI usage restrictions include at least one of AI usage restriction information representing a restriction for AI usage, a context presence flag representing whether context information for the AI usage restriction information is present, or the context information representing a context for the AI usage restriction information, and
wherein the AI usage restrictions are obtained from a network abstraction layer (NAL) unit of the bitstream.

2. The method of claim 1, wherein a value of the AI usage restriction information is restricted to fall within a range of 0 to 3.

3. The method of claim 2, wherein the AI usage restriction information of a first value represents that it is unusable for AI training,
wherein the AI usage restriction information of a second value represents that it is unusable for generative AI, and
wherein the AI usage restriction information of a third value represents that it is unusable in any AI application.

4. The method of claim 3, wherein a smaller value is allocated to the AI usage restriction information representing that it is unusable for the AI training than to the AI usage restriction information representing that it is unusable for the generative AI.

5. The method of claim 1, wherein the bitstream further includes restriction number information representing a number of restriction entries to be signaled.

6. The method of claim 5, wherein the at least one of the AI usage restriction information, the context presence flag, or the context information is signaled from the bitstream based on the restriction number information.

7. The method of claim 1, wherein the context information of a first value represents a commercial use,
wherein the context information of a second value represents a non-commercial use,
wherein the context information of a third value represents an official government use, and
wherein the context information of a fourth value represents a research and academic use.

8. The method of claim 1, wherein the context information is signaled from the bitstream based on a value of the context presence flag being 1, and
wherein the context information is not signaled from the bitstream based on the value of the context presence flag being 0.

9. A method, comprising:
receiving a video picture to be encoded;
encoding the received video picture to generate video information related to the video picture;
generating artificial intelligence (AI) usage restrictions; and
generating a bitstream including the video information and the AI usage restrictions,
wherein the AI usage restrictions include at least one of AI usage restriction information representing a restriction for AI usage, a context presence flag representing whether context information for the AI usage restriction information is present, or the context information representing a context for the AI usage restriction information, and
wherein the AI usage restrictions are encoded into a network abstraction layer (NAL) unit of the bitstream.

10. A computer-readable storage medium for storing a bitstream generated by the method according to claim 9.

11. A method, comprising:
generating a bitstream, wherein the bitstream is generated based on receiving a video picture to be encoded, encoding the received video picture to generate video information related to the video picture and generating artificial intelligence (AI) usage restrictions; and
transmitting data including the bitstream,
wherein the AI usage restrictions include at least one of AI usage restriction information representing a restriction for AI usage, a context presence flag representing whether context information for the AI usage restriction information is present, or the context information representing a context for the AI usage restriction information, and
wherein the AI usage restrictions are encoded into a network abstraction layer (NAL) unit of the bitstream.
